(19) United States
(12) Patent Application Publication
(10) Pub. No.: US 2010/0027756 A1
(43) Pub. Date: Feb. 4, 2010

(54) ORAL SENSOR HOLDER AND ASSEMBLY OF SUCH A SENSOR HOLDER AND A DIGITAL SENSOR

(75) Inventor: René Albèrt Hof, Alphen aan den Rijn (NL)

Correspondence Address: Barnes & Thornburg LLP, Atlanta Financial Center, 3343 Peachtree Road N.E., Suite 1150, Atlanta, GA, 30326-1428, US

(73) Assignee: Duphamed B.V. a corporation

(21) Appl. No.: 11/568,755

(22) PCT Filed: May 6, 2005
(86) PCT No.: PCT/NL2005/000344

§ 371 Date: Sep. 17, 2007

(30) Foreign Application Priority Data
May 6, 2004 (NL) 1026122

(51) Int. Cl. G03B 42/04

(52) U.S. Cl. 378/170

(57) ABSTRACT

An oral sensor holder for holding a digital sensor is already known on the market. The digital sensor is placed in the oral cavity by means of this holder and then irradiated by an external radiation source, being an X-ray source. A relatively quick and relatively bright and clear dental photographic image can thus be obtained of the situation in the mouth, in particular the dental situation, of a person. The invention relates to an improved oral sensor

The invention relates to a holder for holding a digital sensor in the mouth. The invention also relates to an assembly of such a sensor holder and a digital sensor, wherein the sensor is accommodated releasably in the sensor holder.

A comparable sensor holder is already known on the market. The digital sensor is placed in the oral cavity by means of this holder and then irradiated by an external radiation source, being an X-ray source. The collected data can be transmitted to a processing unit via a cable connected to the digital sensor. A relatively quick and relatively bright and clear dental photographic image can thus be obtained of the situation in the mouth, in particular the dental situation, of a person. The existing sensor holders are constructed from a metal rod to which a plastic biting surface is coupled in releasable manner. The biting surface is herein connected to clamping means for clamping the digital sensor. The metal rod also functions as support structure for an orienting ring for facilitating directing of the radiation source at the digital sensor. The known sensor holder has a multiple drawbacks. A significant drawback of the known sensor holder is that the sensor holder is relatively robust, heavy and constructed from a plurality of components. It is therefore relatively awkward, tiring and unpleasant for a person to clamp the sensor holder with the teeth in the oral cavity in stable manner for a determined period of time. Due to the relatively robust design it is moreover not readily possible in the case of determined bite occlusions to place the sensor adequately in the oral cavity, which is generally a considerable obstacle to the generating of clear photographic images. This is usually the case particularly with young children. In addition to the relatively unwieldy construction of the known sensor holder, the sensor holder is relatively expensive.

The invention has for its object to provide a relatively user-friendly sensor holder.

The invention provides for this purpose an oral sensor holder, comprising an integrally constructed first holder part adapted to be received in an oral cavity, which first holder part comprises at least one biting element and coupling means for coupling the sensor holder to a digital sensor, and a second holder part connected integrally to the first holder part, which second holder part is adapted to be positioned outside the oral cavity, and which second holder part is provided with at least one cable holder for holding a cable forming part of the sensor. By constructing the sensor holder integrally the quantity of material required to form the sensor holder as well as the dimensioning of the sensor holder can be minimized, which considerably increases the user-friendliness of the relatively light and compact sensor holder. It is furthermore possible to manufacture the sensor holder in a single production step, for instance by means of injection moulding, which generally reduces significantly the cost price of the sensor holder according to the invention. The first holder part is adapted in particular for intra-oral application, while the second holder part is adapted in particular for extra-oral application. By holding or at least guiding the cable connected to the sensor at a distance from the sensor, the relative orientation of the sensor and the associated cable can be substantially fixed. The relative substantial fixing of such an orientation has a number of important advantages. A first important advantage of fixedly holding or at least guiding the cable is that uncontrolled hanging of the cable, which could result in an (undesirable) askew position of the sensor and thereby in disruption of the dental photographic image to be generated, can be prevented. Furthermore, it is generally disagreeable for a user when the cable is not guided through the cable holder but only rests on the lip of the user. Nor is it preferred to apply an intra-oral cable holder, which will generally also adversely affect the user-friendliness of the sensor holder. It is noted that the digital sensor as well as the cable connected to the sensor will preferably be enclosed in a protective cover, generally manufactured from plastic, in which the sensor and the cable are releasably accommodated. The assembly of the sensor, the cable and the protective cover can further be accommodated in the sensor holder according to the invention. An advantage of the protective cover is that direct contact of saliva present in the oral cavity with the sensor, and thereby corrosion of the sensor, can be prevented.

The cable will generally be adapted for physical conduction of electrical signals from the sensor to an external processing unit. It is however also possible to envisage the cable being adapted as an antenna for transmitting and optionally receiving signals via the ether. As already stated, the cable holder has the advantage that a cable, usually a relatively thin wire, can be guided out of the oral cavity in controlled manner, wherein the inconvenience for the user can be minimized. Damage to the cable can moreover be prevented by guiding the cable out of the oral cavity relatively economically by means of the cable holder. For this purpose it is also possible to envisage applying a plurality of cable holders. The cable will generally be connected on one side to the sensor and on the other side to a plug for connecting the cable to a socket forming part of the processing unit. Since such a cable is provided on two sides with a thickened element, it is not possible to guide the cable in axial direction through a relatively closely fitting channel. The cable holder therefore preferably comprises a sheath enclosing a receiving space for at least a part of the cable, which sheath is provided with an interrupted sheath segment extending substantially axially. In this manner at least a part of the cable can be arranged in the cable holder by means of lateral displacement of the cable relative to the cable holder, irrespective of the dimensioning and geometry of components connected to (the ends of) the cable. The thickness of the lateral passage opening of the generally linearly recessed sheath segment is generally in the order of magnitude of the diameter of the cable. In the case of a cable with a diameter between 2.8 and 3.2 millimetres, a passage opening of 2.8 millimetres in the sheath can for instance be applied. In a particular preferred embodiment, the cable holder substantially takes the form of a clip in order to be able to accommodate the cable, or at least a part thereof, in reliable manner. It is possible here to envisage the cable being clamped in the cable holder by means of exerting a bias. In general however, no bias will be exerted on the cable. In order to prevent the cable being removing from the cable holder as a result of gravitational forces, the recessed sheath segment is preferably oriented substantially in upward direction in the normal operating position of the sensor holder according to the invention.

The cable holder can be integrally connected to the second holder part, but is preferably displaceable along the second holder part, whereby the cable holder can be positioned in optimal manner relative to the sensor holder, wherein the optimal position usually depends on situational conditions such as the facial width of a user, the flexibility and the mass of the cable, and so on.

In a preferred embodiment, the second holder part is provided with orienting means, in particular an orienting ring, in order to facilitate directing of a radiation source at the digital sensor. The second holder part herein preferably extends laterally relative to the oral cavity, wherein the orienting means are then situated outside the oral cavity. The orienting means are generally formed by an orienting ring, using which the (X-) radiation incident on the digital sensor can be aligned. The orienting means are preferably displaceable along the second holder part in order to allow relatively easy adjustment of the sensor holder to an optimal positioning and dosage relative to the user. Furthermore, the installation of the first holder part in the oral cavity can generally take place more easily if the mutual distance between the orienting means and the first holder part is increased. In a particular preferred embodiment, the second holder part is provided with at least one stop for bounding (on one side) the displaceability of the orienting means. In order to enable optimizing of the alignment of the radiation source, usually an X-ray tube, it is generally important to pre-define the ideal mutual distance between the digital sensor and the orienting means. This ideal mutual distance is preferably determined here by the stop against which the orienting means can be displaced along the second holder part. In a particular preferred embodiment, the cable holder, preferably formed by a cable clip, is coupled to the orienting means. Since the orienting means are generally situated outside and along the oral cavity, the cable can be guided out of the oral cavity in relatively advantageous manner. In a particular preferred embodiment, the orienting means are provided with a plurality of cable holders, which cable holders are integrally connected to the orienting means. A single orienting ring can thus be adapted for instance for two-sided positioning relative to the head of a user, which increases the efficiency of the orienting ring.

The biting element is generally formed by a flat element on which a user can exert force via the teeth. In order to increase the user-friendliness of the biting element, a comparatively ergonomic design of biting element is preferably applied, wherein the inconvenience for the user is minimized. The thickness of the biting element is moreover reduced compared to the thickness of conventional biting elements. A thickness of the biting element is preferably applied of a maximum of 1.2 millimetres, in particular a thickness between 0.8 and 1 millimetre. At such a thickness sufficient mechanical strength can on the one hand be provided for use of the sensor holder according to the invention, in particular for fixing of the coupling means, and the user-friendliness can on the other hand be increased. An improved occlusion, and therefore a relatively great effective range, can moreover be realized by the relatively thin, and preferably small, biting surface of the biting element, whereby interdental spaces can be observed relatively sharply, even in users with an overbite. In a preferred embodiment, the thickness of the biting element is related to the thickness of the cable of the sensor, wherein the thickness of the biting element is preferably equal to or greater than the thickness of the cable in order to be able to prevent, or at least counter, damage to the cable through biting.

It is noted in this respect that the relatively thin, small and/or ergonomic biting element can likewise be applied in an integrally constructed sensor holder as according to claim 1, although this sensor holder is not provided (any longer) with one or more cable holders.

The sensor holder is preferably manufactured substantially from plastic. Plastic is generally relatively inexpensive and can be deformed relatively easily into the integrally constructed sensor holder according to the invention. Plastic furthermore has a relatively low specific density, whereby the sensor holder can have a relatively low mass, which further increases the user-friendliness of the sensor holder. In particular, the sensor holder is substantially manufactured from synthetic resin. The advantage of synthetic resin is that synthetic resin can be processed relatively simply, whereby a highly stable sensor holder can be manufactured. It will be apparent that the sensor holder can also be manufactured from other types of material, such as for instance ceramic and/or biological materials.

In order to allow optimal positioning of the digital sensor in the oral cavity using a sensor holder according to the invention, the sensor holder preferably takes a non-linear and ergonomic form in order to minimize the inconvenience for a user. The sensor holder can herein take a (partially) curved form, but can also be provided with one or more corners.

In another preferred embodiment, the sensor holder has a disposable form. Since the sensor holder according to the invention can be manufactured relatively simply, inexpensively and quickly, it is possible to envisage applying the sensor holder once-only or only a few times. The disposable embodiment of the sensor holder may be particularly attractive from a hygiene viewpoint. The sensor holder can herein be replaced after (once-only) use with a new (sterile) unused sensor holder. In addition, use of a disposable sensor holder increases the freedom of design in respect of material choices and shaping, as less stringent requirements are made of the durability of the sensor holder than in the case of a conventional sensor holder.

In a preferred embodiment, the sensor holder can be applied in at least two opposite rotational states. By embodying the sensor holder according to the invention such that the sensor holder can be applied in a plurality of rotational states via axial rotation, preferably over an angle of substantially 180°, a single sensor holder can be applied with multiple parts of a set of teeth. The sensor holder can for instance thus be adapted for application in a top left part of the teeth as well as a bottom right part of the teeth.

The sensor holder is preferably adapted to generate at least one of the following recorded images: anterior, posterior, endo and bitewing. In a particular preferred embodiment, a specifically constructed holder is applied per type of recorded image, wherein the design of the sensor holder can be optimized for the specific type of recorded image. It will however be apparent that universally applicable sensor holders can also be applied, which will however be generally constructed less optimally for the different types of recorded image.

The coupling means are preferably adapted to clamp the sensor. For this purpose the coupling means can comprise a plurality of clamping fingers which can engage at least partly round the sensor. The dimensioning of the coupling means is preferably minimized in order to also minimize the number of pressure points in the oral cavity during use of the sensor, which will generally enhance the photographic quality and limits the radiation time of the user.

The invention also relates to an assembly of a sensor holder according to the invention and a digital sensor, wherein the sensor is accommodated releasably in the sensor holder and wherein a cable connected to the sensor is held fixedly by the cable holder at a distance from the sensor. In a particular preferred embodiment, the digital sensor and more preferably the cable are substantially enclosed with a protective material layer, such as for instance a plastic sleeve. Advantages of the assembly according to the invention have already been described at length in the foregoing.

The invention will be elucidated on the basis of non-limitative exemplary embodiments shown in the following figures. Herein:

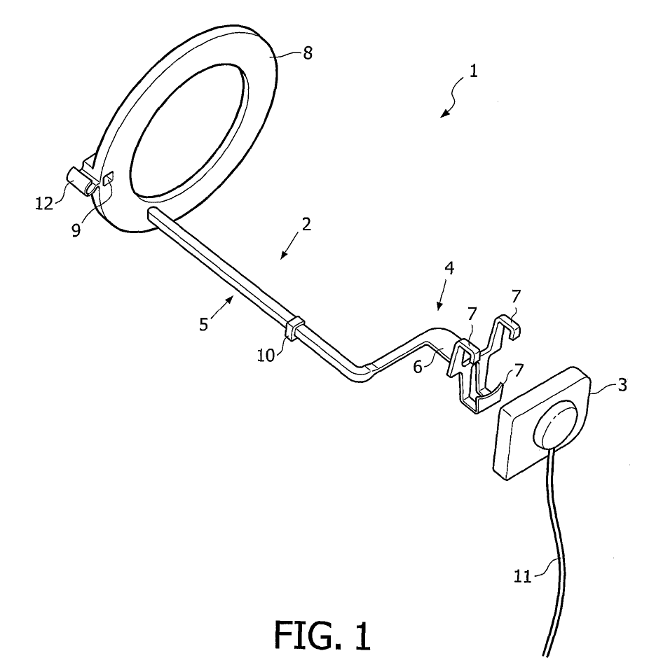

FIG. 1 shows a perspective view with exploded parts of an assembly of a sensor holder according to the invention and a sensor accommodated in the sensor holder, and

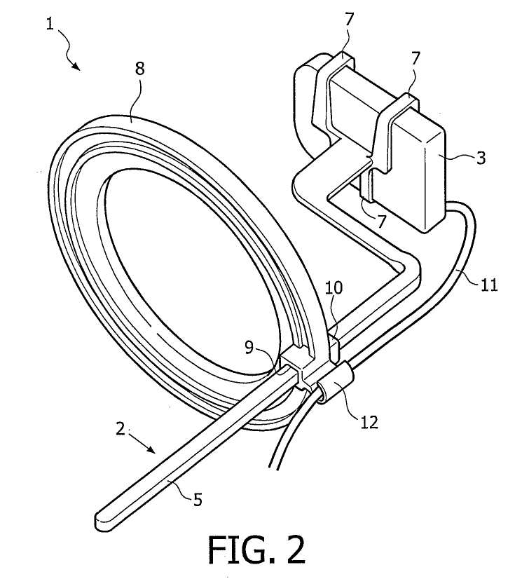

FIG. 2 shows a perspective view of the assembly of FIG. 1 in a position of use.

FIG. 1 shows a perspective view with exploded parts of an assembly I of a sensor holder 2 according to the invention and a sensor 3 accommodated in sensor holder 2. Sensor holder 2 is herein embodied in relatively compact and integral manner in a lightweight plastic, which generally minimizes the inconvenience for a user. Sensor holder 2 is constructed virtually from a first holder part 4 and a second holder part 5. The first holder part 4 is adapted to be received in an oral cavity of a user and is provided on one side with a biting surface 6 and clamping means 7 for clamping digital sensor 3. The second holder part 5 takes a linear form and under normal conditions is situated outside the oral cavity of the user. The second holder part 5 functions particularly as support structure for an orienting ring 8 for the purpose of facilitating irradiation of sensor 3 by means of for instance X-rays. Orienting ring 8 is herein provided with a passage 9 for the second holder part 5 in order to allow orienting ring 8 to slide along second holder part 5. The second holder part 5 is herein provided with a stop edge 10 to bound the displacement of orienting ring 8 along the second holder part 5. In the situation engaging on stop edge 10, the orienting ring 8 will generally be situated at an ideal distance from sensor 3 to be able to achieve a relatively accurate alignment relatively quickly. Sensor 3 is provided with an antenna 11 to enable data exchange between sensor 3 and an external control unit (not shown). Orienting ring 8 is provided with an antenna holder 12 to enable guiding of antenna 11 out of the oral cavity in relatively efficient and effective manner.

FIG. 2 shows a perspective view of assembly 1 according to FIG. 1 in a position of use. Orienting ring 8 is here displaced over second holder part 5 as far as stop edge 10. In this shown position the alignment of an X-ray tube relative to digital sensor 3 can take place relatively quickly and accurately. Sensor 3 is now accommodated releasably in clamping means 7 under bias. Antenna 11 of sensor 3 is guided along the second holder part 5 and is partially enclosed by antenna holder 12. FIG. 2 shows clearly that the cross-section of both the second holder part 5 and the passage 9 of orienting ring 8 takes a square form in order to prevent undesirable rotation of orienting ring 8 relative to the second holder part 5. It will be apparent that sensor 3 can be coupled releasably to sensor holder 2 in diverse ways. A particular advantage of the shown assembly 1 is that parts, usually molars, of both the lower teeth and the upper teeth can be visualized in a single intra-oral X-ray recorded image.

It will be apparent that the invention is not limited to the exemplary embodiments shown and described here, but that within the scope of the appended claims numerous variants are possible which will be self-evident to a skilled person in this field.

1. Oral sensor holder, comprising:
an integrally constructed first holder part adapted to be received in an oral cavity, which first holder part comprises at least one biting element and coupling means for coupling the sensor holder to a digital sensor, and
a second holder part connected integrally to the first holder part, which second holder part is adapted to be positioned outside the oral cavity, and which second holder part is provided with at least one cable holder for holding a cable forming part of the sensor.

2. Sensor holder as claimed in claim 1, characterized in that the cable holder comprises a sheath enclosing a receiving space for at least a part of the cable, which sheath is provided with an interrupted sheath segment extending substantially axially.

3. Sensor holder as claimed in claim 2, characterized in that the cable holder substantially takes the form of a clip.

4. Sensor holder as claimed in any of the claims 1-3, characterized in that the cable holder is displaceable along the second holder part.

5. Sensor holder as claimed in any of the claims 1-3, characterized in that the cable holder is integrally connected to the second holder part.

6. Sensor holder as claimed in any of the foregoing claims, characterized in that the second holder part is provided with orienting means in order to facilitate directing of a radiation source at the digital sensor.

7. Sensor holder as claimed in claim 6, characterized in that the orienting means are displaceable along the second holder part.

8. Sensor holder as claimed in claim 7, characterized in that the second holder part is provided with at least one stop for bounding the displaceability of the orienting means.

9. Sensor holder as claimed in any of the claims 6-8, characterized in that the cable holder is connected to the orienting means.

10. Sensor holder as claimed in claim 9, characterized in that the orienting means are provided with a plurality of cable holders, which cable holders are integrally connected to the orienting means.

11. Sensor holder as claimed in any of the foregoing claims, characterized in that the biting element takes an ergonomic form.

12. Sensor holder as claimed in any of the foregoing claims, characterized in that the thickness of the biting element amounts to less than 1.2 millimetres.

13. Sensor holder as claimed in any of the foregoing claims, characterized in that the sensor holder is manufactured substantially from plastic.

14. Sensor holder as claimed in claim 13, characterized in that the sensor holder is manufactured substantially from synthetic resin.

15. Sensor holder as claimed in any of the foregoing claims, characterized in that the sensor holder takes a non-linear form.

16. Sensor holder as claimed in any of the foregoing claims, characterized in that the sensor holder takes a disposable form.

17. Sensor holder as claimed in any of the foregoing claims, characterized in that the sensor holder can be applied in at least two opposite rotational states.

18. Sensor holder as claimed in any of the foregoing claims, characterized in that the sensor holder is adapted to generate at least one of the following recorded images: anterior, posterior, endo and bitewing.

19. Assembly of a sensor holder as claimed in any of the claims 1-18 and a digital sensor, wherein the sensor is accommodated releasably in the sensor holder and wherein a cable connected to the sensor is held fixedly by the cable holder at a distance from the sensor.

20. Assembly as claimed in claim 19, characterized in that the digital sensor is substantially enclosed by a protective material layer.
